(19) United States
(12) Patent Application Publication
(10) Pub. No.: US 2008/0182518 A1
(43) Pub. Date: Jul. 31, 2008

(54) Multimedia switching system

(75) Inventor: Shoa-Hung Lo, Taipei City (TW)

Correspondence Address: BACON & THOMAS, PLLC, 625 SLATERS LANE, FOURTH FLOOR, ALEXANDRIA, VA, 22314, US

(73) Assignee: BLUEPACKET COMMUNICATIONS CO., LTD., TAIPEI CITY (TW)

(21) Appl. No.: 12/010,775

(22) Filed: Jan. 30, 2008

(30) Foreign Application Priority Data
Jan. 31, 2007 (TW) 096103553

(51) Int. Cl. H04B 7/26

(52) U.S. Cl. 455/41.3

(57) ABSTRACT

A multimedia switching system includes a dongle and multiple receivers; the dongle and each receiver contains a Bluetooth wireless transmission module; the dongle is connected to a computer; a multimedia installation is externally connected to each receiver; any receiver while picking up a trigger signal sends a signal requesting connection to the dongle thus creating connection with the dongle; and video or audio signals outputted from the computer are further outputted from the multimedia installation externally connected to the receiver.

### BACKGROUND OF THE INVENTION

(a) Field of the Invention

The present invention is related to a multimedia switching system, and more particularly, to the multimedia switching system that applies Bluetooth wireless communication technology.

(b) Description of the Prior Art

Other than a work aid, a computer is also becoming a device for playing multimedia at home. A user may change the location at home to enjoy multimedia for several reasons. For example, the user may move from bedrooms to living room and from living rooms to study rooms while listening to online music. This becomes very inconvenient since the user just has to move along with his/her computer or carry a music disk to play it with another computer or audio equipment in the new room.

Bluetooth wireless technology relates to a short-distance wireless communication technology rapidly developed in recent years. Bluetooth applied signals transmission capable of penetrating through barriers without being subject to any directional limitation is ideal for data transmission between electronic installations. To solve the problem of inconvenience as described above, the user may adapt a dongle connected to the computer and wear a Bluetooth earphone to receive audio signals outputted from the computer to enjoy the music wherever he/she may move around from one room to another. However, the user may lose his/her aural comprehension since he/she wears the earphone for a longer time.

### SUMMARY OF THE INVENTION

A primary purpose of the present invention is to provide a multimedia switching system to enhance convenient playing and manipulation of playing a multimedia installation.

To achieve the purpose, the present invention includes a dongle and multiple receivers, and both the dongle and each receiver contain a Bluetooth wireless transmission module respectively; and the dongle is connected to a computer and those receivers are externally connected to the multimedia installation, e.g., a TV set or a speaker. When any receiver picks up a trigger signal, the receiver sends a signal requesting connection to the dongle. After the connection is made between the receiver and the dongle, multimedia signals outputted from the computer are transmitted to the multimedia installation externally connected to the receiver. Once another receiver picks up the trigger signal, it sends a signal requesting connection to the dongle, the dongle in turn interrupts its current connection to switch to create connection with the other receiver.

A multimedia switching system of the present invention provides the following advantages:

1. It allows a user easy and uninterrupted access to multimedia information at different places without the necessity to configure a complicated system; and

2. It also allows the user to answer web phone while enjoying the multimedia information.

### BRIEF DESCRIPTION OF THE DRAWINGS

FIG. 1 is a block chart of a preferred embodiment of the present invention.

FIG. 2 is a block chart of another preferred embodiment of the present invention.

FIG. 3 is a schematic view showing an operation status of another preferred embodiment yet of the present invention.

### DETAILED DESCRIPTION OF THE PREFERRED EMBODIMENTS

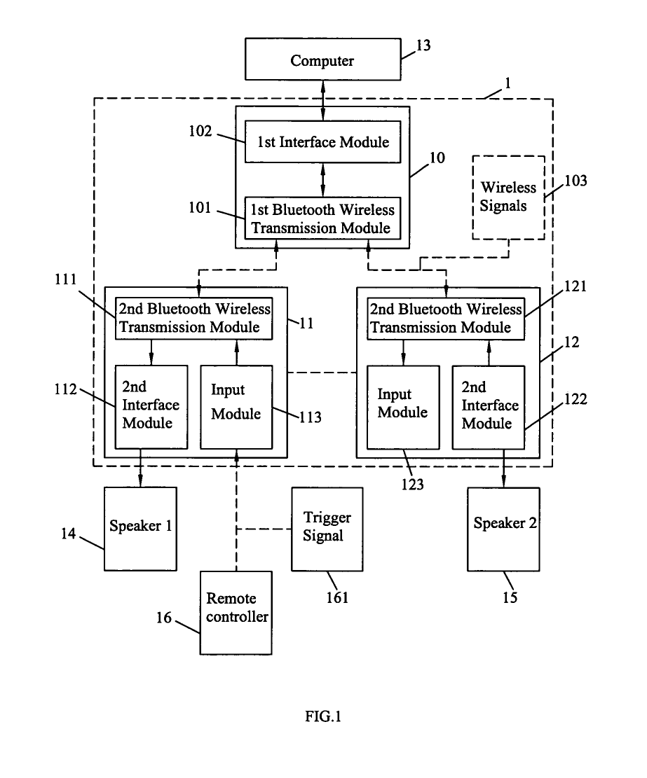

Referring to FIG. 1 for a block chart of a preferred embodiment of the present invention, a multimedia switching system 1 includes a dongle 10 and multiple receivers 11, 12, etc. The dongle 10 contains a first Bluetooth wireless transmission module 101 and a first interface module 102. The dongle 10 is electrically connected to a computer 13 through the first interface module 102. Each receiver contains a second Bluetooth wireless transmission module, a second interface module, and an input module. For example, the receiver 11 is provided with a second Bluetooth wireless transmission module 111, a second interface module 112, and an input module 113. The receiver 12 includes a second Bluetooth wireless transmission module 121, a second interface module 122 and an input module 123. The second Bluetooth wireless transmission module 111 or 112 executes wireless signal transmission with the first Bluetooth wireless transmission module 101. Wherein, a wireless signal 103 complies with Bluetooth protocol. The first interface module 102 is preferred to be an USB (universal serial bus) interface module. Upon the multimedia switching system 1 is initialized, the first Bluetooth wireless transmission module 101 is searching for the presence of a second Bluetooth wireless transmission module nearby. If the second Bluetooth wireless transmission module is detected, the first Bluetooth wireless transmission module 101 registers information such as Bluetooth address, connection mode or ID (identification) code related to the second Bluetooth wireless transmission module (e.g. 111 or 121), and then the receiver (e.g. 11 or 12) is connected with the dongle 10. Only one receiver can be connected with the dongle at a time.

The receiver is connected to an external multimedia installation through the second interface module. That is, both of receivers 11, 12 are respectively connected to a first speaker 14 and a second speaker 15 through the second interface module 112 and another second interface module 122. The input module 113 and another input module 123 are provided to receive a trigger signal, wherein the second interface module is preferred to be an AV (audio/video) interface terminal, S interface terminal or a digital terminal. When an input module of any receiver in the multimedia switching system 1 picks up a trigger signal 161, the receiver picking up the trigger signal 161 sends a signal requesting connection to the dongle 10 such that the external installation connected to the receiver of picking up the trigger signal 161 can make connection with the computer 13. Once the connection is established, the dongle on the computer 13 thus execute wireless data transmission to the receiver. That is, the computer 13 transmits video or audio signals wirelessly to the externally connected installation for playing. The input module may include a key or an IR (infrared ray) signal-receiving module for a user to press the key to input a trigger signal or a control signal (e.g., Play, Pause, or Stop) while the IR signal-receiving module picks up a trigger signal or a control signal (e.g., Play, Pause or Stop) transmitted from an IR remote controller.

According to FIG. 1, when the input module 113 receives the trigger signal 161 transmitted from a remote controller 16 or another trigger signal generated from a key disposed on the receiver 11, the second Bluetooth wireless transmission module 111 sends a signal requesting connection to the first Bluetooth wireless transmission module 101 to create connection. Upon the connection is created, audio signals transmitted from the computer 13 are delivered to the first speaker 14 for playing. If the user carrying the remote controller 16 approaches the receiver 12 and sends the trigger signal or pushes the key disposed on the receiver 12, the input module 123 picks up the trigger signal 161 transmitted by the remote controller 16 and the second Bluetooth wireless transmission module 121 sends a signal requesting connection to the first Bluetooth wireless transmission module 101 for requesting connection. Meanwhile, the first Bluetooth wireless transmission module 101 interrupts its connection with the second Bluetooth wireless transmission module 111 and switches to another second Bluetooth wireless transmission module 121 to create connection. Those audio signals outputted by the computer 13 are then transmitted to the second speaker 15 for playing,

An input module may receive a control signal if and when required. When connection is created between the first Bluetooth wireless transmission module 101 and the second Bluetooth wireless transmission module, the receiver transmits the control signal to the computer 13 to manipulate an application program executed by the computer 13. The input module is related to a key signal-receiving module for receiving a trigger signal or a control signal generated when the key disposed on the receiver is pressed, or related to an IR signal receiving module to pick up a trigger signal or a control signal transmitted from an IR remote controller. All these signals can be used in remotely controlling the function of the application program executed by the computer 13.

The user may firstly run a music application program on the computer 13 to play a music file. Since Bluetooth wireless communication is not vulnerable to be affected by barriers, multiple receivers can be respectively placed in different rooms, e.g., living rooms, study rooms, and bedrooms with each receiver connected to its dedicated speaker. The user may carry a remote controller 16 and send the trigger signal 161 to the receiver placed in the room which the user is in; or may press the key disposed on the receiver in the room for the receiver to create connection with the dongle 10 and allow the speaker in that same room to output audio signals of a music file stored in and played by the computer 13. Accordingly, the user enjoys the convenience of uninterrupted music while moving around different rooms at home.

The dongle 10 may store a driver program as applicable. When the user connects the dongle 10 with the computer 13, the dongle 10 automatically installs the driver program to the computer 13 to achieve results of plug-and-play. The first Bluetooth wireless transmission module 101 may contain multiple profiles, e.g., an AV profile and handfree profile, and can switch among different profiles.

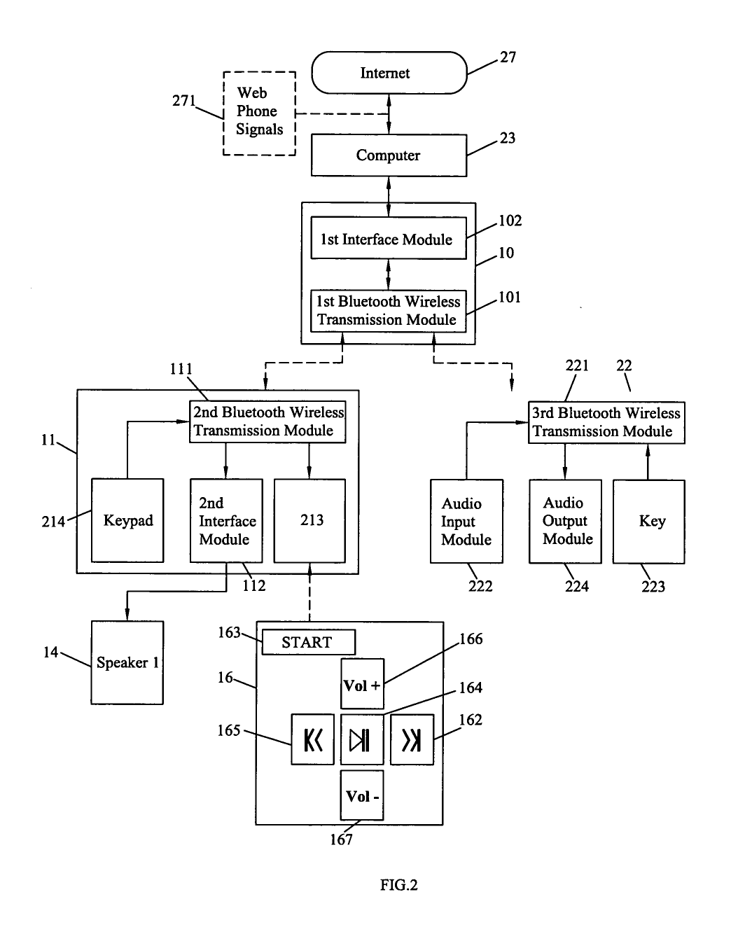

FIG. 2 shows a block chart of another preferred embodiment of the present invention. Wherein, the input module to the receiver 11 contains a keypad 214 and an IR signal-receiving module 213. A computer 23 executes an application program of music file and a web phone program while connecting Internet 27. When the user presses the keypad 214 to generate a trigger signal or a Start key 163 on the remote controller 16 to send the trigger signal to be picked up by the IR signal-receiving module 213 and further transmitted to the second Bluetooth wireless transmission module 111 for the receiver 11 to create connection with the dongle 10 and for the first speaker 14 to play those audio signals outputted from the computer 23. Both of the receiver 11 and the dongle 10 transmit signals in AV profile. The user may operate a Play/Pause key 164, a Next key 162, a Last key 165, a Volume Up key 166, and a Volume Down key 167 to manipulate the playing program of the music file. The similar manipulation may also be achieved by pressing the keypad 214.

Furthermore, the user may wear a Bluetooth earphone 22 containing a third Bluetooth wireless transmission module 221, an audio source input module 222, an audio source output module 224, and a talking key 223. The first Bluetooth wireless transmission module 101 has already detected the presence of the third Bluetooth wireless transmission module 221 and registered information related to the third Bluetooth wireless transmission module 221. When the computer 23 picks up a web phone signal 271 from Internet 27, the web phone program produces a prompt ringing to be outputted through the first speaker 14 to prompt the user an incoming web phone. Upon hearing the prompt ringing, the user presses the talking key 223 to drive the third Bluetooth wireless transmission module 221 to send a signal requesting connection to the first Bluetooth wireless transmission module 101 to request connection. In turn, the dongle 10 generates a pause signal that is transmitted to the computer 23 to pause the execution of the application program of music file. The first Bluetooth wireless transmission module 101 interrupts connection with the second Bluetooth wireless transmission module 111 while the AV profile is switched to the handfree profile to create connection with the third Bluetooth wireless transmission module 221. Upon the connection is created, the user answers the web phone through the audio source output module 224 and talks to a caller at the remote end through the audio input module 222. When the talking is over, the user press the key 223 to hang up the call and drive the third Bluetooth wireless transmission module 221 to send a signal to the first Bluetooth wireless transmission module to achieve disconnection. The first Bluetooth wireless transmission module 101 interrupts its connection with the third Bluetooth wireless transmission module 221 and the handfree profile is switched back to the AV profile to connect with the second Bluetooth wireless transmission module 111 once again. Meanwhile, the dongle 10 generates a play signal and sends it to the computer 23 to resume the execution of the play application of music file. Those audio signals outputted by the computer 23 are thus further outputted from the first speaker 14 through wireless transmission.

Accordingly, the user may enjoy the music in different rooms at home through the multimedia switching system of the present invention, and go back to listen to the music soonest upon completing answering a web phone.

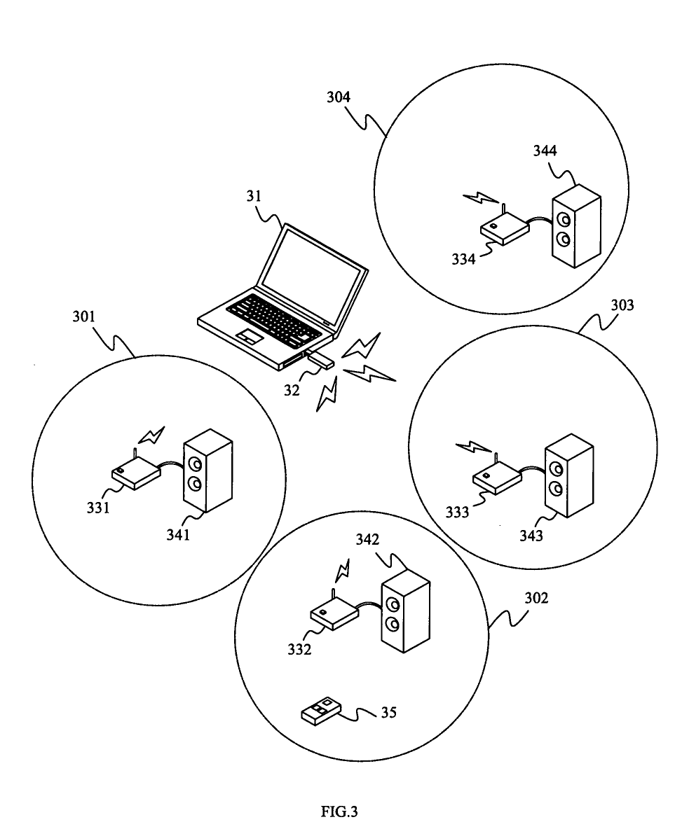

Now referring to FIG. 3 for a schematic view showing an operation status of another preferred embodiment yet of the present invention, a multimedia switching system includes a dongle 32, four receivers 331, 332, 333, and 334 with each disposed with a keypad. The dongle 32 is connected to a notebook 31 through an USB interface and all four receivers 331, 332, 333, and 334 are respectively connected to four speakers 341, 342, 343, and 344 each with an AV terminal. The user may place those four receivers 331, 332, 333, and 334 respectively connected with four speakers 341, 342, 343, and 344 each in his bedroom, study room, living room, and kitchen. By triggering the key disposed on the receiver 331, 332, 333, or 334 to activate the receiver to create connection with the dongle; or alternatively, the user may carry a remote controller 35 with him/her to activate the connection between the receiver selected and the dongle. Areas 301, 302, 303, and 304 respectively represent four areas of signals from the remote controller to be picked up by those four receivers. The user may stay in the study room to operate the notebook 31 and run the multimedia play program to play his/her favorite MP3 file by activating the receiver 332 for the MP3 music to be outputted from the speaker 342. If the user desires to enjoy the music in the bedroom, he/she simply carries the remote controller 35 and goes to the bedroom to activate the receiver 331 and the MP3 music is switched to and outputted from the speaker 341. If the user desires to stop the music, he/she does not have to go back to the study room to operate the notebook 31, he/she just sends the pause signal right in the bedroom with the remote controller 35 and the pause signal to pause is transmitted to the dongle 32 through the receiver 331. The pause signal is then converted and sent to the notebook 31 through the USB interface, thereby pausing the execution of the multimedia play program. If the user moves to a new area and does not have the remote controller 35 with him/her, he just presses the key disposed on the receiver dedicated for that area to activate the receiver for playing the MP3 music through the speaker connected to that receiver.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A multimedia switching system including a dongle equipped with a first Bluetooth wireless transmission module and a first interface module, the dongle being electrically connected to a computer through the interface module; and multiple receivers with each equipped with a second Bluetooth wireless transmission module, a second interface module, and an input module, the second Bluetooth wireless transmission module executing wireless data transmission with the first Bluetooth wireless transmission module, the second interface module being externally connected to a multimedia installation, and the input module receiving a set of trigger signals; when the input module of any receiver upon picking up a trigger signal for the second Bluetooth wireless transmission module of the receiver to send a signal requesting connection to the first Bluetooth wireless transmission module; and data transmission being executed between an electronic installation externally connected to the receiver picking up the trigger signal and the computer.

2. The multimedia switching system as claimed in claim 1, wherein the input module includes an IR signal-receiving module, and the trigger signal is generated from a remote controller.

3. The multimedia switching system as claimed in claim 1, wherein the input module includes a keypad for a user to input different trigger signals.

4. The multimedia switching system as claimed in claim 1, wherein the externally connected multimedia installation relates to a speaker, a monitor, a TV set, an earphone, or a hand-held device.

5. The multimedia switching system as claimed in claim 1, wherein the first interface module relates to an USB interface module.

6. The multimedia switching system as claimed in claim 1, wherein the second interface module relates to an AV interface terminal, a S interface terminal or a digital terminal.

7. The multimedia switching system as claimed in claim 1, wherein the computer executes a multimedia play program to output a set of video or audio signals to be further outputted on an electronic installation externally connected to the receiver having picked up the trigger signal.

8. The multimedia switching system as claimed in claim 1, wherein the first Bluetooth wireless transmission module includes at least one profile.

9. The multimedia switching system as claimed in claim 1, wherein the input module further receives a set of control signals and sends those signals through the receiver to the computer to manipulate the application program executed by the computer.

10. The multimedia switching system as claimed in claim 9, wherein the control signal is generated from a remote controller.
